(19) United States
(12) Patent Application Publication
(10) Pub. No.: US 2003/0222026 A1
(43) Pub. Date: Dec. 4, 2003

(54) Use of water soluble demulsifiers in separating hydrocarbon oils from clays

(76) Inventors: Jeffrey M. Carey, Mentor, OH (US); Alvin E. Haas, Mentor, OH (US); Thomas M. Keir, Broadview Heights, OH (US); John S. Manka, Chardon, OH (US)

Correspondence Address: The Lubrizol Corporation, Patent Administrator Mail Drop 022B, 29400 Lakeland Boulevard, Wickliffe, OH, 44092-2298, US

(21) Appl. No.: 10/344,911

(22) PCT Filed: Sep. 4, 2001
(86) PCT No.: PCT/US01/27408

(51) Int. Cl. C02F 1/00

(52) U.S. Cl. 210/708

(57) ABSTRACT

Oil based drilling fluids (muds) that include clays can be broken into at least three layers of their respective components (oil, water, and clay) by adding a few weight percent of a high HLB surfactant prediluted in water. Centrifugation can accelerate this separation process. The resulting oil, water, and clay layers can thereafter be more cost effectively recycled or disposed of following the process. In another embodiment an additional surface active agent is added to facilitate breaking the drilling mud into three or more phases without the centrifuge.

### FIELD OF INVENTION

Dispersions of particulate matter in hydrocarbon oils are used in a variety of applications (such as oil well drilling fluids) where a high viscosity lubricious composition is desired. At some point in the life of a drilling mud it has to be disposed of or recycled due to contamination or the completion of drilling in a particular location. The presence of emulsified water, inorganic particulate, hydrocarbons, etc. in a single high viscosity mixture makes reclamation of components difficult or disposal environmentally risky. Two methods of separating the solids from the hydrocarbon oil phase are set forth.

### BACKGROUND OF THE INVENTION

Drilling fluids (muds) are available in a variety of forms including water based muds, oil based muds, and muds using a combination of oil and water. During drilling operations the muds become contaminated with debris removed by the drilling bits and with liquids (water, brines, etc.) that enter the hole from above or from liquids that leach into the hole from deposits in the ground. The mud composition can change due to liquid contaminants. Many of the solid contaminants can be removed by screening or other mechanical separations based on density or particle size. Mechanical separation of oversized solid material (drilling debris) typically takes with it a liquid layer of the drilling mud which generally is removed before the solid material is discarded.

Some clays, used as viscosity builders in the drilling muds, are modified to make them organophilic such that the layers in the clay separate from each other and adsorb oil exists. This helps build viscosity in the drilling mud. A simple mechanical separation of such clay from the oil generally cannot remove all of the trapped oil between the layers of the clay. Simple dilution of a spent drilling mud with water or oil generally generates more waste material with only a slight decrease in viscosity. Emulsified water or brine that may be present in the drilling mud further complicates the separation process and may build viscosity.

### SUMMARY OF THE INVENTION

It has been discovered that a high HLB (hydrophile-lipophile balance) surfactant especially when prediluted in water facilitates the breaking of dispersions of clay in hydrocarbon oil into three separate layers comprising an oil rich layer, a water rich layer and a layer rich in the clay (inorganic) component. Different drilling muds vary in dispersion stability thereby requiring slightly different concentrations of surfactant or predilution to optimize the separation process. The high HLB surfactant can be characterized by its chemical structure and the fact that it has high solubility in water (e.g. at least soluble to 5 g/100 g of water). The separation of these three layers from an oil based drilling mud can be expedited or facilitated by mixing and centrifugation of the mixture.

While a high HLB surfactant of the disclosed structure will consistently break dispersions of clay in hydrocarbon oil with the use of a centrifuge, it is desirable in another embodiment to break the dispersion and separate a majority of the clay or other fine particle inorganic matter from the hydrocarbon without the initial used of a centrifuge to expedite the separation. In this second embodiment a process using a blend of the high HLB surfactant and a surface active compound comprising the ester/salt reaction product of an alkenyl substituted succinic anhydride or similarly substituted succinic acid with a dialkylalkanolamine has been found to effectively break the dispersion of clay in hydrocarbon oil into three layers (top oil layer, middle water layer, and bottom clay layer) without the need for a centrifuge for the initial crude separation.

Further in both embodiments, (the first embodiment with or the second embodiment without mechanical assistance in separation) significant amounts of the recovered water phase can be recycled and used to break addition samples of clay dispersed in hydrocarbon oil, optionally with some addition high HLB surfactant and, in the second embodiment, the surface active agent to replace lost surfactant and lost surface active agent. In the second embodiment both the recovered water and oil phase can be recycled and used to break additional dispersions of clay in hydrocarbon oil. Recycling saves not only the water and oil phases but also saves significant amount of the high HLB surfactant and surface active agent. In some embodiments the two liquid layers and any flock layers therein or there between can be centrifuged (or other mechanical forces applied) to further purify the hydrocarbon oil layer, water layer or clay (inorganic) layer.

The present invention provides a method for destabilizing an oil based dispersion of inorganic material in hydrocarbon oil, comprising:

(a) contacting the oil based dispersion with an aqueous composition comprising a surfactant represented by the structure

(R—X—)ₙ—W

where;

each R is independently a hydrocarbyl group containing at least 8 carbon atoms,

n is at least 1,

W is a group containing at least 6 carbon atoms and at least one ether linkage for every 6 carbon atoms thereof, and

each X is selected from the group consisting of

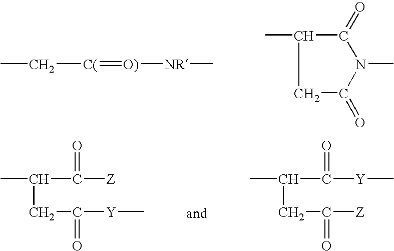

where:

each Y is independently —O— or —NR′—,

each Z is independently OM or NR′₂,

each R′ is independently hydrogen or a C₁ to C₁₈ alkyl group,

M is hydrogen, a monovalent metal or one valence of a polyvalent metal, a quaternary ammonium ion, a C₁ to C₁₈ alkyl group, or —(CH₂CHR″O)ₐ—H, where R″ is hydrogen or a methyl group and a is 1 to 40;

wherein the group X is connected to the group W through (at) the group —Y—, ═N—, or —NR′—; and X is connected to R through a CH or CH₂ group;

whereby subsequent to said contact processing the dispersion is more easily separated into a hydrocarbon oil phase, a water phase, and an inorganic phase.

Thereafter the separate phases can be independently recycled or disposed of.

The present invention further provides surfactants suitable for such use, including a composition represented by the structure

(R—X—)ₙ—W

where:

n is 1;

R is independently a hydrocarbyl group containing at least 8 carbon atoms,

W is a group containing at least 6 carbon atoms and at least one ether linkage for every 6 carbon atoms thereof, having no unreacted amino groups

and where X is selected from the group consisting of

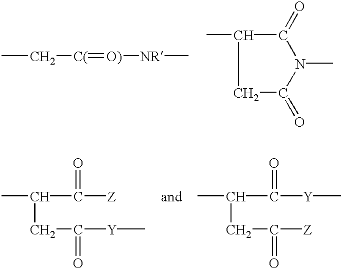

where:

Y is —O— or —NR′—,

Z is OM or NR′₂,

each R′ is independently hydrogen or a C₁ to C₁₈ alkyl group,

M is hydrogen, a monovalent metal or one valence of a polyvalent metal, a quaternary ammonium ion, a C₁ to C₁₈ alkyl group, or —(CH₂CHR″O)ₐ—H, wherein a is 1 to 40 and R″ is hydrogen or a methyl group;

wherein the group X is connected to the group W through the group Y, ═N—, or —NR′—; and X is connected to R through either a CH or CH₂ group.

The second embodiment also provides for inclusion of a surface active agent comprising the half ester of the reaction of an alkenyl substituted succinic anhydride or similarly substituted succinic acid reacted with a dialkylalkanolamine in the process for breaking the emulsion. Further when the high HLB surfactant and the surface active agent are not sufficient to break the dispersion upon simple stirring or shaking, the inclusion of a hydrocarbon solvent, which can be the same as the hydrocarbon oil, helps separate the hydrocarbon oil from the clay and break the dispersion.

The process of the second embodiment is preferably set up as a continuous process where the water rich phases and hydrocarbon oil and/or solvent phases are reused at least several times in breaking additional dispersions of clay in hydrocarbon solvent. In a situation where the water and hydrocarbon oil recovered are reused significant amounts of the high HLB surfactant and the surface active agent would be carried back into the process minimizing the additional amounts needed in subsequent batches. The byproducts of the process would be recovered hydrocarbon oil and a solid clay component with significantly reduced hydrocarbon oil content.

### DETAILED DESCRIPTION OF THE INVENTION

In the process of the present invention, the term hydrocarbon oil is used in its common meaning that the component is a liquid at room temperature and is primarily composed of hydrogen and carbon atoms. It may include unsaturation and single or multiple aromatic rings. It may include some small percentage of atoms other than carbon and hydrogen e.g. less than 5 wt. %, more desirably less than 2 wt. % and preferably less than 1 wt. % of atoms other than carbon and hydrogen. While commercially important hydrocarbon fluids are often obtained as petroleum distillates, the hydrocarbon oil of this invention may be other than a petroleum distillate. The hydrocarbon oil of this invention may be a hydrogenated petroleum distillate, hydrocracked petroleum distillate, or even an alpha olefin polymer. It may be a paraffinic oil such as described in U.S. Pat. No. 6,096,690. Alternatively it may be a diesel fuel. The aromatic component of diesel fuel has a toxic effect on some marine life and preferred diesel fuels have an aromatic content of less than 3, more desirably less than 2 and preferably less than 1 wt. % aromatic. Preferably the hydrocarbon oil has a viscosity of less than 5 centapoise at 25° C. and more preferably less than 1.5 centapoise. Desirably the hydrocarbon oil has a minimum flash point above 60° C. It may further include additives common to diesel fuel or lubricating oils in amounts up to 5 or 10 wt. %. These include lubricating agents, antioxidants, pour point depressants, dispersants and fuel improvers that promote clean combustion in compression ignition engines. The hydrocarbon solvent used to facilitate separation in the second embodiment can be a hydrocarbon oil as described above or another hydrocarbon chemical. Optionally a hydrocarbon solvent with a lower flash point than the hydrocarbon oil used in the dispersion can be tolerated in the process.

An important component of the present invention is the high HLB surfactant. The surfactant can be represented by the structure (R—X—)ₙ—W. The expression “represented by the structure” is meant to include obvious variants and equivalent of a given structure, including isomers, tautomers, and the like. In the structure above, each R is independently a hydrocarbyl group containing at least 8 carbon atoms, and preferably up to 40 carbon atoms. Preferably each R is an alkyl or alkenyl group of 12 to 32, or more preferably 16 to 18 carbon atoms. The R groups are intended to provide a measure of hydrophobic character to the surfactant molecule.

In the above structure, each X is a carbonyl-containing linking group, represented by one or more of the structures

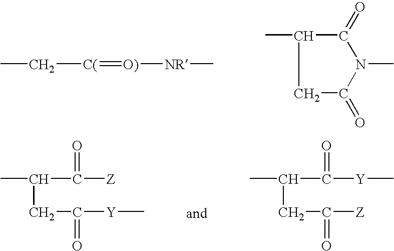

where:

each Y is independently —O— or —NR′—,

each Z is independently OM or NR′₂,

each R′ is independently hydrogen or a C₁ to C₈ alkyl group,

M is hydrogen, a monovalent metal or one valence of a polyvalent metal, a quaternary ammonium ion, a C₁ to C₁₈ alkyl group, or —(CH₂CHR″O)ₐ—H, R″ is hydrogen or methyl, and a is 1 to 40.

In the structures shown, it is recognized that normally the group X is connected to the group W through (at) the group —Y—, ═N—, or —NR′—, as the case may be, and X is connected to R through (at) a CH or CH₂ group in R. It will be recognized that these are ester, amide, or imide structures.

Preferably X is a structure containing two carboxylic moieties, that is, a succinic or maleic acid-type structure. Preferably Y is NR′, or optionally NH.

Preferably Z is OM and preferably M is a monovalent metal, preferably an alkali metal, more preferably sodium.

In a preferred embodiment, each X group is represented by the structure

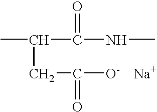

This represents an alkyl or alkenyl-substituted succinamide structure, which is at least in part in the form of the sodium salt. Alkyl and alkenyl-substituted succinamides are well known materials which have been set forth, i.e., in U.S. Pat. No. 4,664,834. They can be prepared by, first, reacting an olefin (providing the R group) with the desired unsaturated carboxylic acid such as fumaric acid or a derivative of such an acid such as maleic anhydride at a temperature in the range of, for example, 160° C. to 240° C., preferably 185° C. to 210° C. Generally these reactions are conducted at an atmospheric pressure, although elevated pressures can also be used. Free radical inhibitors (e.g., t-butyl catechol) can be used to reduce or prevent the formation of polymeric by-products. Further details can be found in Benn et al., “The Ene Reaction of Maleic Anhydride with Alkenes,” J. C. S Perkin II (1977) pp 535-7. After the initial reaction with of the olefin with the unsaturated acid or equivalent, the alkylated product is further reacted with a suitably terminated W group to form an ester or, preferably, an amide.

In the structure (R—X)ₙW, n is at least 1 but is normally 2 or more, preferably 2. Corresponding to the value of n, W is a mono- or polyvalent group.

The W group of the surfactant is believed to provide a measure of hydrophilic character to the molecule. The group W is preferably a polyvalent group, normally a divalent group, so that n in the above formula is normally 2. The W group contains at least 6 carbon atoms, and preferably 20 to 300 carbon atoms, more preferably 40 to 200 carbon atoms, and moreover contains at least one ether linkage for every 6 carbon atoms, and preferably for every 4 carbon atoms. The group W preferably comprises polymerized ethylene oxide monomers and propylene oxide monomers. In one embodiment, W is represented by the structure

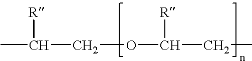

where n is at least 2 and each R″ is independently hydrogen or methyl. That is, monomer units derived from ethylene, propylene, or mixtures thereof can be used. In a preferred embodiment, W is represented by the structure

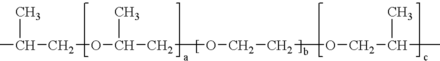

where a and c are integers which together equal 2 to 20 (preferably 3 to 20) and b is an integer in the range of 5 to 80 (preferably 5 or 10 to about 30 or 40).

In a preferred embodiment, the reactant used to form the W group is terminated by amine functionality, to provide the amides characteristic of the preferred X groups, above. W then represents the central moiety of an amine-terminated poly(oxyalkylene). Preferred examples of such amine terminated materials can be described as alpha, omega diaminopolypropyleneoxide-capped poly(oxyethylene)s, when n is 2. If n is 1, W would be a corresponding monoamino polyoxyalkylene moiety, the non-nitrogen terminated end of which would normally be terminated with a nonreactive group such as an alkyl (e.g., methyl, ethyl, propyl) group. It is also possible that additional amino groups are present within the structure of W. These materials are available from the Huntsman corporation. A material referred to as Huntsman™ XTJ-502 (also referred to as Jeffamine™ ED-2003), which is an alpha, omega diamino poly(oxyalkylene) is particularly preferred.

A preferred surfactant for use in the present invention is a sodium salt represented by the structure

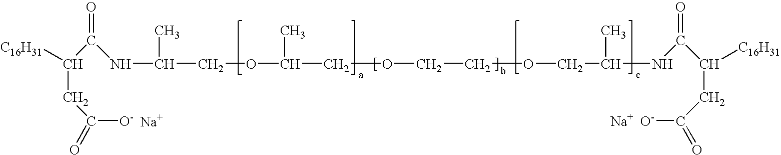

and positional isomers thereof; that is, the C₁₆H₃₁ or other C₁₂-C₃₂ hydrocarbon groups may be attached to either of the two carbon atoms of the succinic group as shown. In this preferred case, a and c are integers which together equal 4 to 6, c is a positive integer, and b is an integer in the range of 5 or 10 to about 30 to 40, and more preferably about 10 to 30. Such materials have good resistance to Ca ion (water hardness) and low sorption onto soil.

In an alternative embodiment, W can be a monovalent moiety containing at least 20 carbon atoms and at least one ether linkage for every 6 carbon atoms thereof, having no unreacted amino groups. One species of W, in this case, is represented by the structure

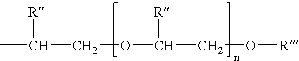

A preferred species of W is that represented by the structure

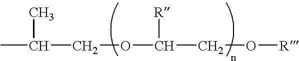

where, in each of the preceding structures, each R″ is independently hydrogen or methyl, R′″ is hydrogen or a C₁ to C₄ alkyl group, and n is at least 5. Preferably the ratio of the hydrogen to methyl groups of R″ is 3:1 to 8:1, preferably 5:1 to 8:1, (e.g., about 19:3), R′″ is a methyl group, and n is 5 to 42, preferably 8 to 42, or 15 to 42, or more preferably 20 to 24 (e.g., about 22).

Alternatively expressed, the preferred surfactant can be described as a reaction product of a hydrocarbyl-substituted succinic anhydride or a reactive equivalent thereof (e.g., diacid form of anhydride) with at least one water-dispersible amine-terminated poly(oxyalkylene). The components are typically prepared by reacting the hydrocarbyl-substituted succinic anhydride with the amine-terminated poly(oxyalkylene) at temperatures of 60° C. to about 160° C., preferably 120° C. to 160° C. The ratio of the anhydride to the diamine is typically 0.1:1 to 8:1, preferably 1:1 to 4:1, and more preferably about 2:1. The resulting material is normally an amid/acid, that is, a half amide. The product can be neutralized with a basic material using methods well known in the art, to form a salt, preferably a sodium salt. Such materials and their preparation are described in greater detail in U.S. Pat. No. 4,664,834.

The above-described high HLB surfactant is used in the application (e.g. in water, clay, hydrocarbon oil etc.) generally at a concentration of about 0.5, 1, or 5 to about 50 weight percent, and preferably from about 0.5 or 1 to about 10 or 20 wt. % based on the weight of the dispersion of clay in hydrocarbon oil, water, high HLB surfactant and optional surface active agent. Initially the high HLB surfactant is made up in water or another polar diluent at a concentration about 10 to 40 or 50 wt. percent and more preferably about 15 to 35 percent (based on active chemical). Diluents other than water include polar solvents such as C₁-C₄ alcohols, acetone, etc. Correspondingly the diluent e.g. water phase is desirably at least 50 wt. % of the blend, more desirably at least 75 wt. % of the blend. The amounts can be adjusted, as needed, to optimize performance for a particular drilling fluid. The surfactant can be dissolved or otherwise dispersed in the water; preferably the surfactant is dissolved. The surfactant in water can be recycled along with some of the water recovered as the water phase from the separation of the drilling fluid into three components.

The surface active agent, which can be used in addition to the high HLB surfactant, is comprised of the ester salt (also known as a half ester salt) of the reaction of an alkenyl substituted succinic acid or succinic anhydride reacted with a dialkylalkanolamine or an alkyldialkanolamine or similar amines having at least one alkanol group. Examples of this chemistry and methods are disclosed in U.S. Pat. No. 4,708,753 (“the '753 patent”), and European Patent Publication EP 0 561 600 A2. In the '753 patent, the succinic acids and anhydrides are described as hydrocarbyl-substituted carboxylic acids, anhydrides, esters and amide derivatives thereof. The above-surface active agent is used in the application (e.g. in water, clay, hydrocarbon oil etc.) generally at a concentration of about 0.5, 1, or 5 to about 50 weight percent, and preferably from about 0.5 or 1 to about 10 or 20 wt. % based on the weight of the dispersion of clay in hydrocarbon oil, water, high HLB surfactant and optional surface active agent.

Reactive equivalents of the alpha-beta olefinically unsaturated carboxylic acid reagents include the anhydride, ester or amide functional derivatives of the foregoing acids. A preferred alpha-beta olefinically unsaturated carboxylic acid is maleic anhydride.

In one embodiment, the succinic agent of this invention is a hydrocarbyl-substituted succinic acid or anhydride represented correspondingly by the formulae

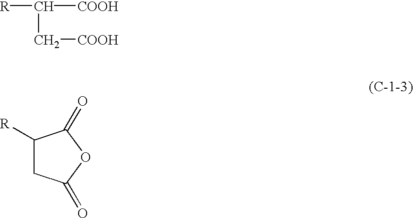

or

wherein in formula (C-I-3), R is hydrocarbyl group of about 12 to about 16 or 32 carbon atoms. The production of such hydrocarbyl-substituted succinic acids or anhydrides via alkylation of maleic acid or anhydride or its derivatives with a halohydrocarbon or via reaction of maleic acid or anhydride with an olefin polymer having a terminal double bond is well known to those of skill in the art and need not be discussed in detail herein.

In one embodiment, R in formula (C-I-3) is a hexadecenyl group.

The “succinic groups” are those groups characterized by the structure

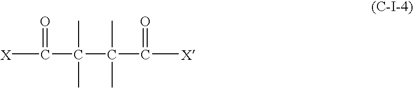

wherein in structure (C-I-4), X and X′ are the same or different provided that at least one of X and X′ is such that the substituted succinic agent can function as a carboxyl acylating agent. That is, at least one of X and X′ must be such that the substituted succinic agent can form, for example, half ester salts with dialkylalkanolamines, and otherwise function as a conventional carboxylic acid acylating agent. Transesterification and transamidation reactions are considered, for purposes of this invention, as conventional acylating reactions.

Thus, X and/or X′ is usually —OH, —O-hydrocarbyl, —O—M⁺ where M⁺ represents one equivalent of a metal, ammonium or amine cation, —NH₂, —Cl, —Br, and together, X and X′ can be —O— so as to form the anhydride. The specific identity of any X or X′ group which is not one of the above is not critical so long as its presence does not prevent the remaining group from entering into acylation reactions. Preferably, however, X and X′ are each such that both carboxyl functions of the succinic group (i.e., both —C(O)X and —C(O)X′) can enter into acylation reactions.

One of the unsatisfied valences in the grouping

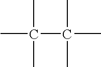

of formula (C-I-4) forms a carbon-carbon bond with a carbon atom in the hydrocarbyl substituent group. While other such unsatisfied valence may be satisfied by a similar bond with the same or different substituent group, all but the said one such valence is usually satisfied by hydrogen; i.e., —H.

In one embodiment, the succinic groups correspond the formula

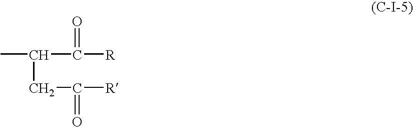

wherein in formula (C-I-5), R and R′ are each independently selected from the group consisting of —OH, —Cl, —O-lower alkyl, or when taken together, R and R′ form —O—. In the latter case, the succinic group is a succinic anhydride group. All the succinic groups in a particular succinic acylating agent need not be the same, but they can be the same. In one embodiment, the succinic groups correspond to

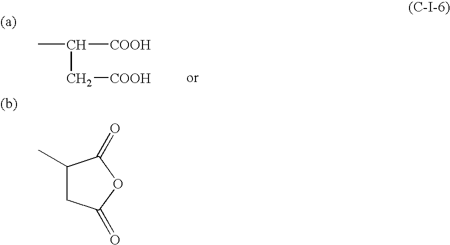

or mixtures of (C-I-6)(a) and (C-I-6)(b). Providing hydrocarbyl-substituted succinic agents wherein the succinic groups are the same or different is within the ordinary skill of the art and can be accomplished through conventional procedures such as treating the hydrocarbyl substituted succinic acylating agents themselves (for example, hydrolyzing the anhydride to the free acid or converting the free acid to an acid chloride with thionyl chloride) and/or selecting the appropriate maleic or fumaric reactants.

Partial esters of the succinic acids or anhydrides can be prepared simply by the reaction of the acid or anhydride with a dialkylalkanolamine. Particularly useful alkyl groups in the dialkyl and alkanol are the lower alkyl groups of 1 to 6 carbon atoms and the lower alkanol groups of 1 to 6 carbon atoms such as methyl, ethyl, and propyl along with alcohols such as methanol, ethanol, allyl alcohol, propanol, cyclohexanol, etc. Preferred alkyl groups are methyl and ethyl and a preferred alkanol is ethanol. Esterification reactions are usually promoted by the use of alkaline catalysts such as sodium hydroxide or alkoxide, or an acidic catalyst such as sulfuric acid or toluene sulfonic acid. A partial ester or half ester can be represented by the formula

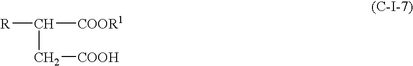

wherein in formula (C-I-7), R is a hydrocarbyl group; and R¹ is a hydrocarbyl group, typically a lower alkyl group.

In addition to the methods described in the '753 patent and in EP 0 561 600 A2 for the preparation of the alkylene substituted succinic anhydride of this invention, such as the one step, two step and direct alkylation procedures, the alkylene substituted succinic anhydride of the present invention can also be made via a direct alkylation procedure that does not use chlorine.

The product of the reaction between any residual COOH groups of the succinic group and any amine such as the amine portion of dialkylalkanolamine comprises at least one salt. This salt can be an internal salt involving residues of a molecule of the succinic group, and the amine portion of the dialkylalkanolamine attached to the succinic group via an ester linkage, wherein one of the carboxyl groups becomes ionically bound to a nitrogen atom within the same group; or it may be an external salt wherein the ionic salt group is formed with a nitrogen atoms is not part of the same molecule. The product of the reaction between succinic group and alkanolamines can also include other compounds such as a half ester and half salt, i.e., an ester/salt.

In one embodiment, the surface active component is made by reacting a linear or branched alkenyl substituted succinic anhydride or diacid with dialkylalkanolamine in a mole ratio of about 1: about (0.4-1.25) respectively, and in one embodiment in an mole ratio of about 1:(0.8-1.2) respectively.

In one embodiment, surface active component is made by reacting a hexadecenyl succinic anhydride with N,N-dimethylethanolamine in an equivalent ratio of about 1: about (0.4-0.6) (which also corresponds to a mole ratio of about 1: about (0.8-1.2)) respectively, and in one embodiment in an equivalent ratio of about 1:0.5 (mole ratio of about 1:1) respectively.

If desired, one or more additional surfactants can be used along with the above-described materials.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:

(1) hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form an alicyclic radical);

(2) substituted hydrocarbon substituents, that is, substituents containing non-hydrocarbon groups which, in the context of this invention, do not alter the predominantly hydrocarbon substituent (e.g., halo (especially chloro and fluoro), hydroxy, alkoxy, mercapto, alkylmercapto, nitro, nitroso, and sulfoxy);

(3) hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

While the dispersion of particulate in a hydrocarbon oil is generally described as a drilling fluid for oil wells, it can generally be any hydrocarbon based dispersion of particulate used for other pulposes. Besides hydrocarbon oil the drilling fluids of this invention typically include a particulate material, usually inorganic, added to build viscosity and density; an emulsifier(s) to help suspend particulate material and aid wetting; wetting agents to help wetting of the variety of substrates that the fluid comes in contact with; viscosifiers that help increase or control fluid viscosity; fluid loss control agents; proppants; and optionally water. These components are more fully explained in U.S. Pat. No. 4,508,628 which is incorporated by reference for its teachings on common components to drilling fluids.

The particulate material, generally inorganic, can be any material that is readily dispersed in hydrocarbon oil, optionally with an emulsifier or wetting agent. Generally it is a clay due to the low cost of clays and their high density relative to water and hydrocarbon oil. While water has a density of about 8 pounds per gallon, drilling fluids often have densities of values such as 18 pounds per gallon due to the addition of high density materials such as clays. This higher density may help stabilize the relative position of fluids in the drilling operation and help the pumping of the drilling debris up from the bottom of the well. Desirably in this invention the particulate material (e.g. clay) is at least 5 wt. %, more desirably at least 10 wt. % and preferably from about 10 or 20 to about 50 wt. % of the drilling fluid. Desirably the particulate material is or is predominantly clay. The clay may include organically modified clay which is generally referred to as clay modified to increase their compatibility and swelling with oils. These are well known to the art.

Water and/or brine may be present in the drilling fluid. Its amount can vary from about 0 to about 40 wt. % and more desirably from about 5 to about 35 wt. % based on the weight of the clay dispersed in hydrocarbon oil. The water can include from about 0 to about 55 wt. % inorganic salts such as sodium chloride, magnesium chloride, sulfates, etc. known to be available commercially or naturally occurring in brines. These components can be added when the drilling fluid is first formulated or can be contaminants picked up as the drilling fluid is used to drill wells.

Emulsifiers can be present in the drilling fluid. They help suspend particulates and emulsify any water that enters the drilling fluid. These are often low HLB materials (surfactants) such as fatty acid soaps. They are further taught in U.S. Pat. No. 4,508,628.

It is known that some of the materials described above may interact in the final formulation, so that the components of the final formulation may be different from those that are initially added. For instance, metal ions (of, e.g., a detergent) can migrate to other acidic sites of other molecules. The products formed thereby, including the products formed upon employing the composition of the present invention in its intended use, may not susceptible of easy description. Nevertheless, all such modifications and reaction products are included within the scope of the present invention; the present invention encompasses the composition prepared by admixing the components described above.

### EXAMPLES

Certain preparations are reported below in Examples for preparing a surfactant believed to be represented by the structure

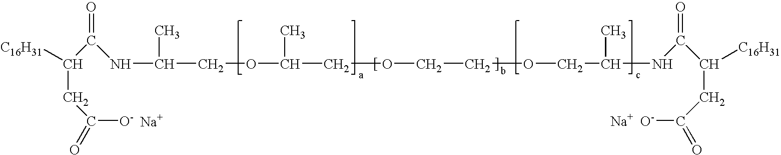

### Example 1

A. 2960 parts of C16 alpha olefin and 100 parts of Amberlyst™ 15 (a product of Rohm & Haas Company identified as a cation exchange resin) are added to a five-liter flask equipped with a nitrogen sparge at 57 L/hr (2.0 std. ft³/hr), stirrer, thermowell, and water trap positioned below a condenser. The mixture is heated to 120° C. for 1.5 hours with the stirrer operating at 350 rpm. The filtrate is isolated.

B. 367.5 parts of maleic anhydride are added to a two-liter flask equipped with stirrer, thermowell, reflux condenser, and gas inlet tube. The maleic anhydride is melted and 765 parts of the product from part A are added. The mixture is heated to 180 to 200° C. for 9.75 hours. The mixture is stripped under a vacuum of 30 mm Hg at 182° C., then cooled to 115° C. The mixture is then stripped under a vacuum of 0.7 mm Hg at 145° C., then cooled to 50° C. The mixture is filtered with diatomaceous earth, and the filtrate retained.

C. 100 parts of Jeffamine™ ED-4000 (a diamine having an average molecular weight of about 4000 and being a primary amine terminated propylene oxide capped polyoxyethylene) and 16.3 parts of the product from part B of this example are mixed together, heated at a temperature of 130° C. for three hours, and then cooled to room temperature. The mixture is diluted with 116.3 parts water in one portion. At 45° C., the mixture is neutralized with 4.0 parts of 50% aqueous sodium hydroxide and filtered to provide the desired product (including diluent water).

### Example 2

A glass lined, jacketed reactor vessel, equipped with an agitator, condenser, and nitrogen flow, and is heated to 85° C. To this vessel is charged 100 parts by weight Jeffamine™ ED-2003 (a diamine with terminal amine groups, internal ether linkages, and a molecular weight of about 2,000), with stirring. To the vessel is added 30.9 parts hexadecenyl succinic anhydride over 30 minutes, during which time the reaction temperature increases to about 93° C. Thereafter the mixture is heated to about 100° C. and maintained at temperature for 3 hours.

The reaction mixture is cooled to 45° C. and 131 parts water is added as diluent, as well as 0.8 parts silicone antifoam agent. The mixture is maintained, with stirring, at 40° C. for 1 hour.

To the mixture is added 9.0 parts of 50% aqueous sodium hydroxide solution over 15 minutes, during which time the temperature is maintained at below 50° C.; stirring is continued to effect complete reaction.

The resulting mixture is filtered through a filter aid to provide 269 parts of product (“Surfactant A”) including diluent water.

### Example 3

Example 2 is substantially repeated except that the Jeffamine™ ED-2003 amine is replaced by 300 parts by weight of a similar material of about 6000 molecular weight. The amount of diluent water added is adjusted accordingly to provide a 50% by weight concentration of chemical in the resulting mixture.

### Example 4

Example 3 is substantially repeated except that the amine is replaced by 60 parts by weight of a similar material of about 600 molecular weight.

### Example 5

Dodecenyl-succinic anhydride is prepared by a method similar to that of Example 1A and B, except that a C12 alkyl group is provided.

To a 2 L, 4-necked flask equipped with a stirrer, thermowell, water condenser, and addition funnel with nitrogen inlet, is charged 500 g of Jeffamine™ ED-2003. The contents of the flask are heated with stirring to 50° C. under a nitrogen flow of 14L/hr (0.5 std. ft³/hr), and the dodecenyl succinic anhydride is added dropwise from the addition funnel over 30 minutes. During the course of addition the temperature of the mixture increases to 87° C. The mixture is further heated to 100° C. with stirring. After 1 hour at 100° C., infrared analysis of the mixture indicates substantially complete reaction. After a total of 4 hours at 100° C., the composition is allowed to cool to 44° C. To the composition, 633 g water is added in one portion, causing the mixture to become slightly foamy. At 44° C., 40 g of 50% aqueous sodium hydroxide solution is added dropwise over 20 minutes. During this addition, the temperature of the composition increases to 49° C. After maintaining the composition at temperature for 40 minutes, it is poured into jars without filtration. The product is a dark brown foamy liquid.

### Example 6

To a 2 L, 4-necked flask equipped with a stirrer, thermowell, water condenser, and addition funnel with nitrogen inlet is charged 575 g of Jeffamine™ M-1000 (a monoamine having an average molecular weight of about 1150 and being a primary amine-terminated propylene oxide capped poly(oxyethylene)). The contents of the flask are heated with stirring to 50° C. under a nitrogen flow of 14 L/hr (0.5 std. ft³/hr), and 161 g of the product from Example 1, part B are added dropwise from the addition funnel over 20 minutes. During the addition the temperature of the mixture increases to 62° C. The mixture is further heated to 100° C. with stirring. After a total of 1 hour at 100° C., the composition is allowed to cool to 45° C. and 736 g water is added in one portion. At 45° C., 40 g of 50% aqueous sodium hydroxide solution is added dropwise over 20 minutes and the reaction mixture is maintained below 50° C. After maintaining the composition at temperature for 1 hour, it is poured into jars without filtration. The product composition is an orange liquid.

### Example 7

The critical micelle concentration (“CMC”) of Surfactant A in water at 22° C. is determined by preparing solutions of the surfactant at differing concentrations. The presence of micelles is determined by the use of pinacyanol dye. The dye turns blue to indicate the presence of micelles. The results indicate that micelles are present at a surfactant concentration of 0.020±0.001 weight percent and above, which corresponds to the CMC. (These values and those in the following examples are corrected to reflect the actual amount of surfactant chemical present, exclusive of diluent water.)

### Example 8

The solubility of Surfactant A in the presence of calcium ion is determined at 22° C. Mixtures of Surfactant A are prepared using water containing 0.001M, 0.01M, and 0.2M CaCl₂. At all concentrations tested, up to 10 times the critical micelle concentration (that is, up to 0.20 weight percent), the surfactant dissolves to form a clear solution without formation of precipitate. Formation of precipitate is determined by the use of pinacyanol dye as in Example 7. Since micelles and precipitate cannot coexist thermodynamically for single surfactant systems, the presence of a blue color, indicating the existence of micelles, likewise indicates the absence of precipitate. The absence of precipitate at all the concentrations evaluated indicates excellent hardness tolerance of Surfactant A.

### Example 9

A commercial diesel fuel based drilling mud was treated with at the 20 wt. % level with a 20 wt. % solution of an emulsifier according to Example 1 where the succinic anhydride is hexadecenyl succinic anhydride and the diamino terminated propylene oxide capped polyoxyethylene had a number average molecular weight of about 1000. The resulting solution was mixed thoroughly. A portion of the material was placed in a test tube and centrifuged for 30 minutes at a preset centrifuge speed. The resulting product had three distinct phases after centrifuging comprising a top hydrocarbon, a middle water and surfactant layer and a bottom clay layer. A drilling mud of this type can be prepared from 55% diesel fuel, 5% asphalt, 3% low HLB emulsifier, 2% organically modified clay, and 35% by wt. barite.

### Example 10

The preparation of polyisobutylene substituted succinic anhydride reacted with N,N-dimethylethanolamine is illustrated. This procedure can be used to make alkylenyl substitued succinic anhydride reacted with N,N-dimethylethanolamine. Additional examples may be found in the '753 patent, EP 0 561 600 A2, and '175 patent. If one wanted to make the reaction product of hexadecenyl succinic anhydride and dimethylethanolamine in a weight ratio of 1000 to 278 used in a later example, one could add the anhydride initially, heat to 49° C., and then add the amine at a rate that allows the batch temperature to rise to 85-93° C. (using external heating if necessary to start the reaction. This could be further reacted until the reaction seems complete, either by chemical analysis or lack of further reaction.

A mixture of 1000 parts (1.69 equivalents) of the polyisobutene-substituted succinic acylating agent having a ratio of succinic groups to equivalent weights of polyisobutene of about 1.91(prepared according to Example 1 of EP 0 561 600 A2) and 1151 parts of a 40 Neutral oil are heated to 65-70° C. with stirring. N,N-dimethylethanolamine (151 parts; 1.69 equivalent) is added such that the reaction mixture exotherms to 82° C. The reaction mixture is heated to 93° C. and held at that temperature for 2 hours. The temperature is adjusted to 160° C., and held at that temperature for several hours (10-15 hours), and then filtered and cooled to room temperature to provide the product. The product has a nitrogen content of 0.90% by weight, a total acid number of 13.0, a total base number of 39.5, a viscosity at 100° C. of 50.0 cSt, a viscosity at 40° C. of 660 centistoke (cSt), a specific gravity of 0.925 at 15.6° C., and a flash point of 75° C. The product is an ester/salt.

### Example 11

The following experiment was performed to demonstrate that a dispersion of clay in hydrocarbon oil could be broken without a centrifuge using a combination of a high HLB surfactant and a surface active agent.

About 0.5 g of a 50:50 blend by weight (the first component being the surfactant of Examples 1-6 where the anhydride is hexadecenyl succinic anhydride and the Jeffamine is a diamino terminated propylene oxide capped polyoxyethylene of about 1000 molecular weight with the second component being a surface active agent generally comprised of the half ester of a hexadecenyl succinic anhydride reacted with dimethylethanolamine in a mole ratio of about 1:1) was diluted with 50 ml of water before adding it to 20 g of commercial drilling mud. The composition of the drilling mud was very similar to that set forth in the example above but being a used drilling mud may have contained some contaminants. These muds are well known and readily commercially available. The blend of surfactant, surface active agent, water, and drilling mud were shaken to mix and settled over several minutes to form a yellow flock layer and a dark solid layer. To this was added 50 ml of diesel fuel and the new blend was vigorously shaken and was allowed to settle for several minutes. It formed 4 layers (from top to bottom: a dark fuel layer, a flock layer, a yellow water layer, and a light colored solids layer).

In a commercial embodiment one would decant the liquid layers off the solid layer and probably recycle the surfactant and surface active agent with the water and hydrocarbon oil. This could be accomplished by using the recovered water and diesel fuel from the process partially or fully in place of the water and diesel fuel used in this example. Then one would add sufficient surfactant and surface active agent to the recycled water and diesel fuel to bring the concentrations back up to those in the example when fresh water and diesel fuel were used. As a significant portion of the diesel fuel from the clay dispersion is recovered in this process for treating drilling mud, there would be a byproduct stream of diesel fuel. Similarly a byproduct stream of clay having lower diesel fuel content than the original drilling mud (dispersion of clay in hydrocarbon oil) is produced. This clay may be further cleaned and possibly sent to a landfill. A centrifuge designed for separating liquids of different densities might be used to further purify water or fuel layers that didn't go back into processing further clay dispersions in hydrocarbon oil.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about”. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent which may be customarily present in the commercial material, unless otherwise indicated. It is to be understood that the upper and lower amount, range, and ratio limits set forth herein may be independently combined. As used herein, the expression “consisting essentially of” permits the inclusion of substances which do not materially affect the basic and novel characteristics of the composition under consideration.

What is claimed is:

1. A method for separating a dispersion of clay in a hydrocarbon oil comprising;
a) preparing a high HLB surfactant in diluent forming a surfactant concentrate,
b) adding the surfactant concentrate to a dispersion of clay in a hydrocarbon oil, and
c) mixing said concentrate and said dispersion of clay thereby breaking the dispersion into a top layer of hydrocarbon oil, middle layer of water, and lower lay of clay.

2. A method according to claim 1, wherein said dispersion of clay in a hydrocarbon oil comprises at least 5 wt. % clay.

3. A method according to claim 1 or 2 wherein the hydrocarbon oil has a viscosity of less than 5 centapoise at 25° C. and a minimum flash point of at least 60° C.

4. A method according to claims 1, 2, or 3, wherein said HLB surfactant has an HLB from about 15 to about 30.

5. A method according to claims 1, 2, or 3, wherein said high HLB surfactant comprises a chemical structure of 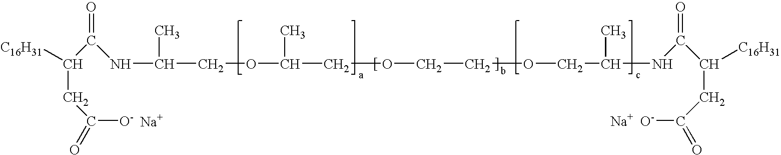
where a and c are integers which together equal 4 to 6 and b is an integer in the range of 5 to 50 and the Na⁺ is sodium, potassium, ammonium, or half of a calcium or magnesium.

6. A method according to claims 1, 2, or 3, wherein said high HLB surfactant is a salt or a half-ester salt of an alkenyl succinate, wherein the alkenyl can have from about 5 to about 50 carbon atoms.

7. A method according to claims 1, 2, or 3, where said high HLB-surfactant comprises a salt of a sorbitan ester ethoxylate have from 5 to 80 ethoxy repeating units.

8. A method according to claims 1, 2, or 3, wherein said high HLB surfactant comprises a sulfonate containing surfactant.

9. A method according to claim 1 or 2, wherein said dispersion of clay includes from about 10 to about 60 wt. % of clay and/or organically modified clay and said hydrocarbon oil comprises a petroleum distillate.

10. A method according to claims 1 or 2, wherein said dispersion of clay includes from about 10 to about 60 wt. % clay.

11. A method according to claims 1 or 2, wherein said dispersion also includes from about 5 to about 35 wt. % water.

12. A method according to claim 11, wherein said water includes from about 5 to about 50 wt. % of an inorganic salt.

13. A method according to claims 1 or 2, wherein said hydrocarbon oil includes a petroleum distillate and said petroleum distillate is from about 10 to about 70 wt. % of said dispersion of clay in a hydrocarbon oil.

14. A method according to claims 1 or 2, wherein said dispersion of clay in a hydrocarbon oil includes from about 0.5 to about 15 wt. % of a low HLB emulsifier.

15. A method according to claim 1, wherein the high HLB surfactant has the formula
(R—X—)ₙ—W
where;
each R is independently a hydrocarbyl group containing at least 8 carbon atoms,
n is at least 1,
W is a group containing at least 6 carbon atoms and at least one ether linkage for every 6 carbon atoms thereof, and
each X is selected from the group consisting of 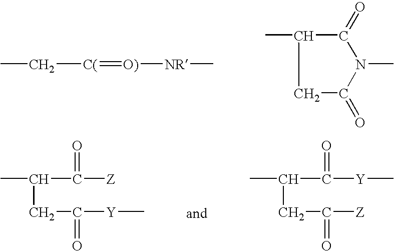
where:
each Y is independently —O— or —NR′—,
each Z is independently OM or NR′₂,
each R′ is independently hydrogen or a C₁ to C₁₈ alkyl group, M is hydrogen, a monovalent metal or one valence of a polyvalent metal, a quaternary ammonium ion, a C₁ to C₁₈ alkyl group, or —(CH₂CHR″O)ₐ—H, where R″ is hydrogen or a methyl group and a is 1 to 40;
wherein the group X is connected to the group W through the group —Y—, ═N—, or —NR′—.

16. The method of claim 15 wherein each R is an alkyl group of about 16 to about 18 carbon atoms.

17. The method of claim 1 wherein each X is a group represented by the structure 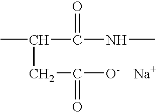
and positional isomers thereof.

18. The method of claim 15 wherein W is a divalent moiety containing about 20 to about 300 carbon atoms and comprising repeating units derived from polymerizing ethylene oxide monomers and propylene oxide monomers.

19. The method of claim 15 wherein W is represented by the structure 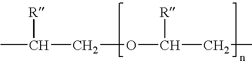
wherein n is at least 2 and each R″ is independently hydrogen or methyl.

20. The method of claim 15 wherein W is represented by the structure 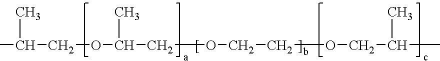
where a and c are integers which together equal 2 to about 20 and b is an integer in the range of 5 to about 70.

21. The method of claim 1 wherein n is 15 and W is a monovalent radical.

22. The method of claim 15 wherein W is represented by the structure 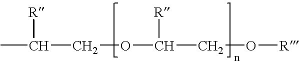
where each R″ is independently hydrogen or methyl, R′″ is hydrogen or a C₁ to C₄ alkyl group, and n is about 5 to about 42.

23. The method of claim 15 wherein W is represented by the structure 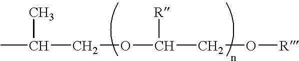
where each R″ is independently hydrogen or methyl, the ratio of such hydrogen to methyl groups being about 3:1 to about 8:1, R′″ is hydrogen or a C₁ to C₄ alkyl group, and n is about 5 to about 42.

24. The method of claim 1 wherein said high HLB surfactant is the reaction product of a hydrocarbyl-substituted succinic anhydride or a reactive equivalent thereof with at least one water-dispersible amine-terminated poly(oxyalkylene) further said reaction product being treated with a base to form a salt.

25. The method of claim 1 wherein the concentration of said high HLB surfactant is about 0.5 to about 10 or 15 weight percent based on the weight of said water, high HLB surfactant and clay dispersion in a hydrocarbon oil.

26. A process for separating a dispersion of clay in a hydrocarbon oil comprising
a) Mixing a dispersion of clay in hydrocarbon oil with
1) a hydrocarbon solvent
2) a high HLB surfactant dispersed in water
3) a surface active agent comprising the half ester/salt reaction product of an alkenyl substituted succinic anhydride or the diacid equivalent thereof reacted with a N,N-dialkylalkanolamine
wherein sufficient hydrocarbon solvent is present to facilitate the separation of the clay from the hydrocarbon oil in the presence of said high HLB surfactant and said surface active agent.

27. A process according to claim 26 wherein said high HLB surfactant dispersed in water is part of a recycle stream from a previous separation of hydrocarbon oil from a dispersion of clay in hydrocarbon oil.

28. A process according to claim 26 or 27, wherein said hydrocarbon solvent comprises recycled hydrocarbon oil from a previous separation of hydrocarbon oil from a dispersion of clay in hydrocarbon oil.

29. A process according to claim 26, wherein said high HLB surfactant is diluted to a concentration of less than 50 wt. % in water before it is added and is used at a concentration between 0.5 and 10 or 15 wt. % in the mixture of the dispersion of clay in hydrocarbon oil, hydrocarbon solvent, high HLB surfactant dispersed in water and surface active agent.

30. A process according to claim 29, wherein the surface active agent is used at a concentration between 0.5 and 10 wt. % in the mixture of the dispersion of clay in hydrocarbon oil, hydrocarbon solvent, high HLB surfactant dispersed in water and surface active agent.

31. A process according to claim 26 wherein the clay concentration in the dispersion of clay in hydrocarbon oil is at least 5 wt. % based on the weight of the dispersion.

32. A process according to claim 26, wherein said hydrocarbon oil and said hydrocarbon solvent have a viscosity of less than 5 centapoise at 25° C. and a flash point of at least 60° C.

33. A process according to claim 26 wherein the high HLB surfactant comprises the chemical structure 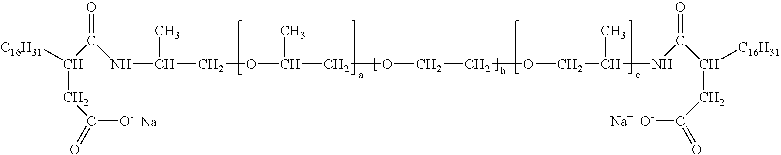
where a and c are integers which together equal 4 to 6 and b is an integer in the range of 5 to 50 and Na⁺ is sodium, potassium, ammonium, or half of a calcium or magnesium ion.

34. A process according to claim 26 wherein the high HLB surfactant has the chemical structure (R—X—)ₙ—W where;
each R is independently a hydrocarbyl group containing at least 8 carbon atoms,
n is at least 1,
W is a group containing at least 6 carbon atoms and at least one ether linkage for every 6 carbon atoms thereof, and
each X is selected from the group consisting of 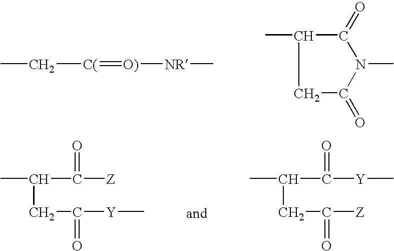
where:
each Y is independently —O— or —NR′—,
each Z is independently OM or NR′₂,
each R′ is independently hydrogen or a C₁ to C₁₈ alkyl group,
M is hydrogen, a monovalent metal or one valence of a polyvalent metal, a quaternary ammonium ion, a C₁ to C₁₈ alkyl group, or —(CH₂CHR″O)ₐ—H, where R″ is hydrogen or a methyl group on each repeating unit and a is 1 to 40;
wherein the group X is connected to the group W through the group Y or —NR′—.

35. A process according to claim 26, wherein the surface active agent comprises the half ester salt from the reaction of an alkenyl substituted succinic anhydride or the diacid equivalent thereof reacted with dialkylalkanolamine.

36. A process according to claim 35, wherein said dialkylalkanolamine is N,N-dimethylethanolamine.

37. A process according to claim 26, wherein said dispersion of clay in hydrocarbon oil includes from about 10 to about 60 wt. % clay and/or organically modified clay.

38. A process according to any of claims 26-36, wherein said hydrocarbon oil is a petroleum distillate.

39. A process according to claim 38, wherein said hydrocarbon oil is diesel fuel.

40. A process according to claims 38 or 39, wherein said hydrocarbon oil is from about 10 to about 70 wt. % of said dispersion of clay in hydrocarbon oil.
